(19) United States
(12) Patent Application Publication
(10) Pub. No.: US 2020/0034524 A1
(43) Pub. Date: Jan. 30, 2020

(54) METHOD FOR PERFORMING USER AUTHENTICATION AND FUNCTION EXECUTION SIMULTANEOUSLY AND ELECTRONIC DEVICE FOR THE SAME

(71) Applicant: LG ELECTRONICS INC., Seoul (KR)

(72) Inventor: Gun Woo HAN, Yongin-si (KR)

(73) Assignee: LG ELECTRONICS INC., Seoul (KR)

(21) Appl. No.: 16/589,920

(22) Filed: Oct. 1, 2019

(30) Foreign Application Priority Data
Aug. 22, 2019 (KR) 10-2019-0102878

(51) Int. Cl. G06F 21/32; G06N 3/04

(52) U.S. Cl. CPC G06F 21/32; G06N 3/04

(57) ABSTRACT

Disclosed are a method and an electronic device for performing user authentication and function execution simultaneously using an artificial intelligence (AI) algorithm and/or a machine learning algorithm. The method for performing user authentication and function execution simultaneously includes receiving image data from an image acquiring unit, extracting a biometric feature image and an additional feature image from the image data, and executing a function corresponding to the additional feature image when the biometric feature image corresponds to an approved user. The function corresponding to the additional feature image is determined using an artificial neural network which is trained in advance to identify a function in accordance with an input image.

### CROSS-REFERENCE TO RELATED APPLICATION

This present application claims benefit of priority to Korean Patent Application No. 10-2019-0102878, entitled “METHOD FOR PERFORMING USER AUTHENTICATION AND FUNCTION EXECUTION SIMULTANEOUSLY AND ELECTRONIC DEVICE FOR THE SAME,” filed on Aug. 22, 2019, in the Korean Intellectual Property Office, the entire disclosure of which is incorporated herein by reference.

### BACKGROUND

### 1. Technical Field

The present disclosure relates to user authentication in an electronic device, and more particularly, to performing user authentication and function execution of an electronic device simultaneously.

### 2. Description of the Related Art

For the sake of a user's convenience, recent electronic devices use and store sensitive information, such as personal identifying information (PII) or sensitive personal information (SPI) of a user. In order to prevent the sensitive information of the user from being exposed to others, the electronic devices are locked such that information in the electronic device can only be accessed after user authentication.

Further, in accordance with development of electronic transaction techniques, remittance or card payment can be performed in many electronic devices. In such electronic devices, it is essential to authenticate whether the electronic transaction is performed by a legitimate user.

In order to execute a desired function in an electronic device which requires user authentication, two steps of operations, including user authentication and function execution, need to be performed. For example, after unlocking the electronic device through the user authentication, the user can execute a desired function (for example, an application) on the electronic device. However, such two steps of operations often cause inconvenience to the user or may be time-consuming.

Korean Patent Application Publication No. 10-2015-0042637 (related art 1) discloses a method of unlocking a terminal using fingerprint recognition and performing a predetermined operation corresponding to a voice instruction using voice recognition. According to related art 1, a voice sensor (microphone) for determining an operation to be performed can be activated only after the user authentication (fingerprint recognition) is successful. Therefore, in related art 1, the unlocking and operation execution are not performed simultaneously but performed sequentially.

### SUMMARY OF THE INVENTION

An aspect of the present disclosure is to perform user authentication and function execution in an electronic device substantially simultaneously.

Another aspect of the present disclosure is to allow a user to select one function to be executed among a plurality of functions when the user authentication is performed.

The the present disclosure is not limited to the above-mentioned aspects and other aspects and advantages of the present disclosure which have not been mentioned above can be understood by the following description and become more apparent from exemplary embodiments of the present disclosure. Further, it is understood that the aspects and advantages of the present disclosure may be embodied by the means and a combination thereof in the claims.

According to embodiments of the present disclosure, a method for performing user authentication and function execution simultaneously and an electronic device therefor identify a biometric feature and an additional feature from an image sensor, determine a function to be executed from the additional feature, and execute the determined function when the biometric feature corresponds to an approved user.

A method for performing user authentication and function execution simultaneously according to a first aspect of the present disclosure includes receiving image data from an image sensor, extracting a biometric feature image and an additional feature image from the image data, and executing a function corresponding to the additional feature image when the biometric feature image corresponds to an approved user.

An electronic device for performing user authentication and function execution simultaneously according to a second aspect of the present disclosure includes an image sensor configured to detect light to generate image data, an identity identifier configured to determine whether the image data corresponds to a user based on a static component of the image data, a function determiner configured to determine a function to be executed based on a dynamic component of the image data, and a function executer configured to execute the determined function when the image data corresponds to an approved user.

An electronic device according to a third aspect of the present disclosure includes an image sensor configured to detect light to generate image data, one or more processors, and a memory storing a computer program. The computer program includes instructions for, when executed by the one or more processors, receiving image data from the image sensor, identifying a biometric feature and an additional feature from the image data, and executing a function corresponding to the additional feature when the biometric feature corresponds to an approved user.

According to one embodiment, the electronic device is in a locked state before receiving the image data, and is unlocked at the same time as the determined function is executed.

According to another embodiment, the executing of a function includes inputting the additional feature image to an artificial neural network which is trained in advance to classify the image as one of a plurality of categories, determining a function to be executed based on the category of the additional feature image determined by the artificial neural network, and executing the determined function.

According to an additional embodiment, the image data includes a face image of the user, and the additional feature includes at least one of a facial expression, a head angle, a mouth shape, or a hand shape.

According to an additional embodiment, the image sensor includes a frame-based image sensor and an event-based image sensor, the biometric feature is identified based on data from the frame-based image sensor, and the additional feature is identified based on data from the event-based image sensor.

According to an additional embodiment, a function map in which a plurality of functions to be executed and a plurality of patterns are mapped to each other is stored in the memory, and the function to be executed can be determined from a pattern of the additional feature image by referring to the function map.

According to the present disclosure, by combining two steps of processes of user authentication and function execution into a one step process, the time taken for the user authentication and function execution can be shortened.

Further, according to the present disclosure, a function to be executed can be selected from an image obtained when the user authentication is performed, thereby increasing a user's convenience.

Effects of the present disclosure are not limited to the above-mentioned effects, and other effects, not mentioned above, will be clearly understood by those skilled in the art from the description of claims

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a block diagram schematically illustrating an electronic device according to an embodiment of the present disclosure;

FIG. 2 is a block diagram schematically illustrating a user authentication and function execution engine according to an embodiment of the present disclosure;

FIG. 3 is a flowchart illustrating a method of simultaneously performing user authentication and function execution according to an embodiment of the present disclosure;

FIG. 4 illustrates an example of a function map in which a plurality of patterns of additional features and a plurality of functions are mapped to each other;

FIG. 5 is a block diagram schematically illustrating an image sensor according to another embodiment of the present disclosure;

FIG. 6 is a circuit diagram illustrating an exemplary pixel circuit of an event-based image sensor;

FIG. 7 is a block diagram schematically illustrating a user authentication and function execution engine according to another embodiment of the present disclosure;

FIG. 8 is a flowchart illustrating a method of simultaneously performing user authentication and function execution according to another embodiment of the present disclosure; and

FIGS. 9A to 9C illustrate various exemplary embodiments to which the present disclosure is applied.

### DETAILED DESCRIPTION

Advantages and features of the present disclosure and methods for achieving them will become apparent from the descriptions of aspects hereinbelow with reference to the accompanying drawings. However, the description of particular example embodiments is not intended to limit the present disclosure to the particular example embodiments disclosed herein, but on the contrary, it should be understood that the present disclosure is to cover all modifications, equivalents and alternatives falling within the spirit and scope of the present disclosure. The example embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, embodiments of the present disclosure will be described in detail with reference to the accompanying drawings. Like reference numerals designate like elements throughout the specification, and overlapping descriptions of the elements will not be provided.

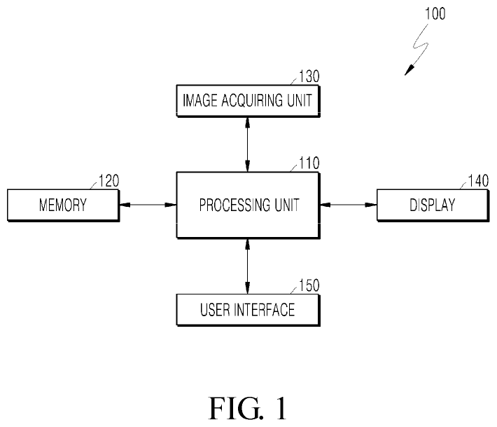

FIG. 1 is a block diagram illustrating an electronic device according to an embodiment of the present disclosure. The electronic device 100 includes a processing unit 110, a memory 120, an image acquiring unit 130, a display 140, and a user interface 150. The processing unit 110 is electrically connected to communicate with the memory 120, the image acquiring unit 130, the display 140, and the user interface 150. The electronic device 100 is any type of device which requires user authentication to execute the function, and may be, for example, a mobile phone, a tablet computer, a laptop computer, a palmtop computer, a desktop computer, a TV, a music player, a game console, or an automated teller machine (ATM), but is not limited thereto.

The processing unit 110 may be any type of data processing device which is implemented as hardware and has structured circuits to perform functions represented by codes or instructions included in a computer program. The processing unit 110, for example, may include one or more of a mobile processor, an application processor (AP), a microprocessor, a central processing unit (CPU), a graphic processing unit (GPU), a neural processing unit (NPU), a processor core, a multiprocessor, an application-specific integrated circuit (ASIC), or a field programmable gate array (FPGA), but is not limited thereto.

The processing unit 110 controls operations of the electronic device 100 in accordance with a computer program stored in the memory 120. For example, the processing unit 110 may control operations of the electronic device 100 in accordance with instructions of an operating system stored in the memory 120. The processing unit 110 may execute operations in accordance with instructions of one or more applications stored in the memory 120.

The memory 120 may be a tangible computer-readable medium which stores a computer program to be executed by the processing unit 110 and/or data associated with the computer programs. The computer program may include an operating system which manages hardware of the electronic device and provides a platform for executing the application. The computer program may further include one or more applications executed on the operating system.

The memory 120 may include authentication data for authenticating a user. The authentication data includes biometric information for recognizing a face, an iris, or a fingerprint of the user. The biometric information is encrypted such that original data is not recognizable, and stored in the memory.

The image acquiring unit 130 may include an image sensor which detects light and converts an intensity of the detected light into an electrical signal, and an image processing unit (IPU) or an image signal processor (ISP) which converts the electrical signal from the image sensor into image data. The image sensor may include a charge-coupled device (CCD) or a complementary metal oxide semiconductor (CMOS) sensor which detects light in a wavelength range including visible light, infrared light and/or ultraviolet light. The image sensor may also include a dynamic vision sensor (DVS) which detects a change in a light intensity that exceeds a threshold. The image acquiring unit 130 may include an infrared light source which emits an infrared ray to recognize an iris, and an iris recognition image sensor which receives light reflected by the iris. The image acquiring unit 130 may also include an LED light source for fingerprint recognition and a fingerprint recognition image sensor which receives light reflected by the finger.

The display 140 is an output device which displays a text, a graphic, an image, or a video in accordance with execution of the operating system or the application.

The user interface 150 is any type of device which receives an input of the user, and may include, for example, at least one of a touch screen coupled with the display 140, input buttons, a keyboard, or a mouse.

Although not illustrated in FIG. 1 for the purpose of simplification, the electronic device 100 may further include various components required for functionality of the electronic device 100 or the convenience of the user, for example, a biometric sensor, a communication module, a GPS module, a speaker, or a microphone.

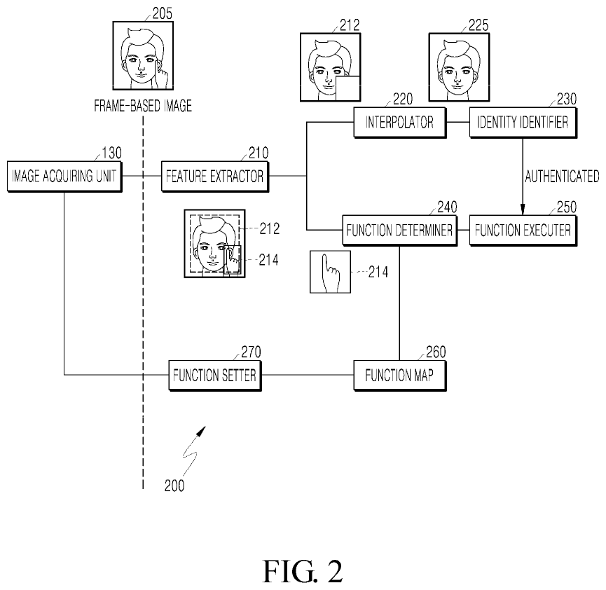

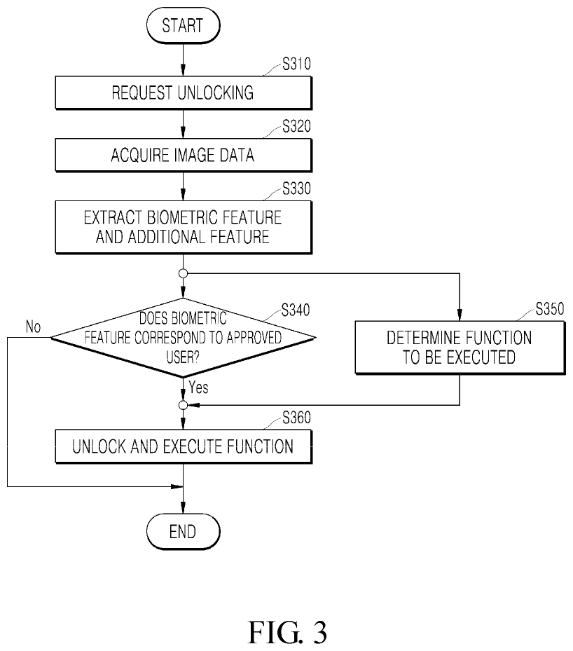

FIG. 2 is a block diagram schematically illustrating a user authentication and function execution engine according to an embodiment of the present disclosure, and FIG. 3 is a flowchart illustrating a method of simultaneously performing user authentication and function execution according to an embodiment of the present disclosure.

The user authentication and function execution engine 200 includes a feature extractor 210, an interpolator 220, an identity identifier 230, a function determiner 240, a function executer 250, a function map 260, and a function setter 270. The user authentication and function execution engine 200 may be a software module which is logically configured using resources of the processing unit 110 and the memory 120, or a hardware module configured by hardware.

In step S310, the electronic device 100 is in a locked state. The user manipulates the user interface 150 of the electronic device 100 (for example, presses buttons or touches a touch screen) to request unlocking.

In step S320, the processing unit 110 activates the image acquiring unit 130 to acquire an image for unlocking the electronic device 100, and the feature extractor 210 of the user authentication and function execution engine 200 receives image data from the image acquiring unit 130. In an embodiment illustrated in FIG. 2, the image acquiring unit 130 uses a frame-based image sensor. The frame-based image sensor is an image sensor which converts light intensities detected by all two-dimensionally arranged photoreceptors (pixel sensors) into pixel signals at every point in time, and generates two-dimensional image data (frame data) for every point in time. Image data received by the feature extractor 210 includes a frame-based image 205. In the present disclosure, the “frame-based image” refers to an image which is generated on a frame basis by the frame-based image sensor. The “frame-based image” includes not only a still image generated as a frame, but also a moving image generated based on the frames.

In step S330, the feature extractor 210 extracts, from the frame-based image 205, a biometric feature image 212 for biometric identification and an additional feature image 214. The biometric feature image 212 may include, for example, a face or an iris, and the additional feature image 214 may include, for example, a hand or a mouth. The feature extractor 210 may separate the additional feature image 214 from the biometric feature image 212. The feature extractor 210 transmits the biometric feature image 212 to the interpolator 220, and transmits the additional feature image 214 to the function determiner 240.

In the frame-based image 205, a partial area of the biometric feature image 212 may be covered by the additional feature image 214. For example, a part of the face may be covered by the hand. A partial area occupied by the additional feature may be removed from the biometric feature image 212 which was separated by the feature extractor 210. In this case, the interpolator 220 may restore the area removed from the separated biometric feature image 212 through interpolation to generate a restored biometric feature image 225. The interpolator 220 may include an artificial neural network (ANN) which is trained in advance to restore a removed area of the image, and the interpolation may be performed using the artificial neural network.

When there is no removed area from the separated biometric feature image 212 (for example, the face is not covered by the hand), the interpolation is not performed. When the area removed from the separated biometric feature image 212 is an important part for biometric identification, the interpolation is not performed. In this case, the interpolator 220 requests the feature extractor 210 to separate the biometric feature image again from a new frame-based image.

In step S340, the identity identifier 230 identifies the identity of the user from the separated or restored biometric feature image 225. For example, the identity identifier 230 determines whether the biometric feature image 225 corresponds to an approved user. The identity identifier 230 may include an artificial neural network which is trained in advance to determine the user's identity from the biometric feature, and the identity identification may be performed using the artificial neural network. When it is determined that the biometric feature image 225 corresponds to the approved user, the identity identifier 230 notifies the function executer 250 that the user is authenticated.

In step S350, the function determiner 240 determines a function to be executed from the separated additional feature image 214. In one embodiment, the function determiner 240 may include an artificial neural network which was trained in advance to identify a pattern from the additional feature image 214. The function determiner 240 may input the additional feature image 214 to the artificial neural network and determine a function to be executed from the pattern in the additional feature image 214 which is identified by the artificial neural network by referring to the function map 260.

The artificial neural network is trained to identify the pattern from the additional feature image 214 by the function setter 270. For example, the function setter 270 may request the user to perform a specific action. For example, the user performs an action of unfolding two fingers and the function setter 270 acquires an image of an additional feature (for example, a finger) using the image acquiring unit 130. The function setter 270 provides the acquired additional feature image to the artificial neural network as training data. The function setter 270 may request the user to repeat the same action until the artificial neural network learns a common pattern from the additional feature image. When the artificial neural network identifies the common pattern from the repeated actions of the user, the function setter 270 may request the user to input a function to be executed for the identified pattern. The function setter 270 maps the function to be executed to the identified pattern to be stored in the function map 260.

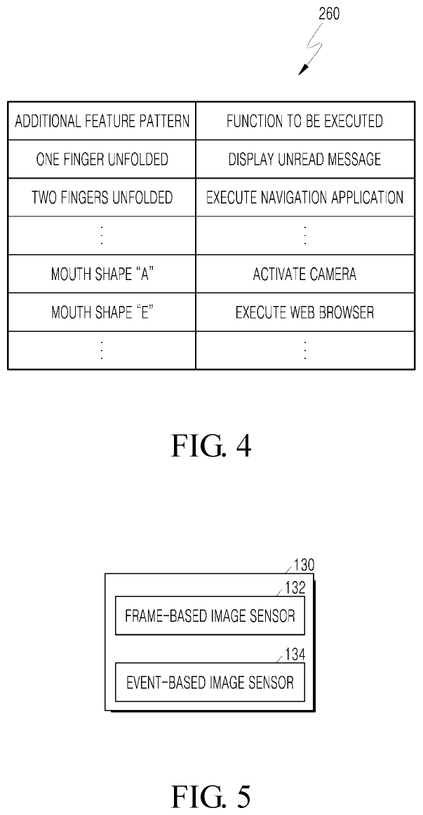

The artificial neural network may identify a facial expression, a head angle, a mouth shape, or a hand shape in the additional feature image 214 as a pattern of the additional feature image 214. In another example, the artificial neural network may identify the number of fingers in the additional feature image 214, or a vowel represented by a mouth shape as a pattern of the additional feature image 214. FIG. 4 illustrates an example of a function map in which a plurality of patterns of additional features and a plurality of functions are mapped to each other. According to the function map 260, when one finger is identified, an unread message in the mobile phone may be displayed, and when two fingers are identified, a navigation application may be executed. When a mouth shape representing an “a” vowel is identified, a camera of the mobile phone may be activated, and when a mouth shape representing an “e” vowel is identified, a web browser may be executed in the mobile phone.

The artificial neural network may determine that the pattern in the additional feature image 214 corresponds to one of the plurality of patterns in the function map 260. The function determiner 240 retrieves a function corresponding to the determined pattern from the function map 260 and notifies the function executer 250 of the retrieved function.

The identity identifier 230 and the function determiner 240 may be configured to perform parallel processing. For example, the identity identifier 230 and the function determiner 240 may be configured on separate processors, or may be configured to use separate neural processing units (NPU). Accordingly, step S340 and step S350 can be substantially simultaneously performed, and the time required to identify the identity and determine a function can be shortened.

In step S360, when the function executer 250 receives notification from the identity identifier 230 that the user is authenticated and receives notification from the function determiner 240 of the identified function, the function executer 250 unlocks the electronic device 100 and executes the identified function simultaneously. Accordingly, the user authentication and the function execution can be substantially and user-selectively performed simultaneously in the electronic device 100.

The feature extractor 210, the interpolator 220, the identity identifier 230, and the function determiner 240 of the user authentication and function execution engine 200 may include an artificial neural network using a deep learning technique.

An ANN is a data processing system modelled after the mechanism of biological neurons and interneuron connections, in which a number of neurons, referred to as nodes or processing elements, are interconnected in layers. ANNs are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections, and acquires problem-solving capability as the strengths of synaptic interconnections are adjusted throughout training. An ANN may include a number of layers, each including a number of neurons. Furthermore, the ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a previous layer.

An ANN may include a deep neural network (DNN). Specific examples of the DNN include a convolutional neural network (CNN), a recurrent neural network (RNN), a deep belief network (DBN), and the like, but are not limited thereto.

An ANN may be classified as a single-layer neural network or a multi-layer neural network, based on the number of layers therein. A general a single-layer neural network may include an input layer and an output layer. In general, a multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer may be the most representative type of artificial neural network which enables deep learning, which is one machine learning technique.

An ANN can be trained by using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An ANN trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

Further, the artificial neural network may be trained by adjusting weights of connections between nodes (if necessary, adjusting bias values as well) so as to produce a desired output from a given input. Furthermore, the artificial neural network may continuously update the weight values through training. Furthermore, a method of back propagation or the like may be used in the learning of the artificial neural network.

FIG. 5 is a block diagram schematically illustrating an image acquiring unit according to another embodiment of the present disclosure. The image acquiring unit 130 may include a frame-based image sensor 132 and an event-based image sensor 134.

The frame-based image sensor 132 is an image sensor which converts light intensities detected by all two-dimensionally arranged photoreceptors (pixel sensors) into pixel signals at every point in time, and generates two-dimensional image data (frame data) for every point in time. The frame-based image sensor 132 may, for example, include a conventional CCD or CMOS sensor.

The event-based image sensor 134 is an image sensor configured to detect a photoreceptor in which a received light intensity is changed greater than a threshold, among the two-dimensionally arranged photoreceptors (pixel sensors). The event-based image sensor 134 is also referred to as a dynamic vision sensor (DVS). The event-based image sensor 134 does not scan all pixels at a fixed frame rate like the frame-based image sensor 132 but rather is reported, by the pixels, of changes in light intensities which exceed the threshold, thereby enabling very fast detection of an object in a field of view. For example, the event-based image sensor 134 can generate event-based image data at a rate of approximately 100 to 1000 Hz while the frame-based image sensor 132 generates frame-based image data at a rate of approximately 20 to 120 Hz.

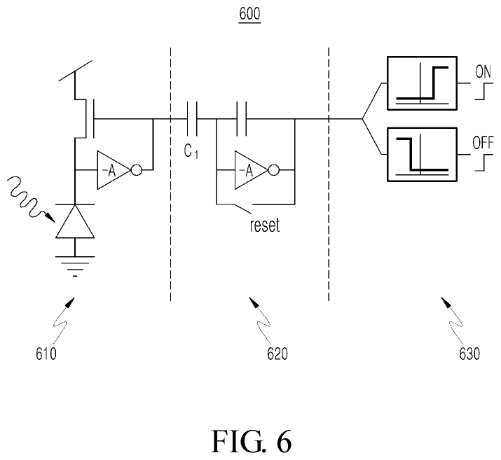

FIG. 6 is a circuit diagram illustrating an exemplary pixel circuit of an event-based image sensor. The pixel circuit 600 includes a photoreceptor 610, a differencing circuit 620, and a comparator 630. The photoreceptor 610 automatically controls a gain of individual pixels, and quickly responds to a change in illumination. The differencing circuit 620 removes DC mismatch and resets a level after generating an event. The comparator 630 thresholds a voltage to generate an ON or OFF event. The event-based image sensor has been described in more detail in P. Lichtsteiner et al., “A 128×128 120 dB 15 μs Latency Asynchronous Temporal Contrast Vision Sensor”, IEEE Journal of Solid-State Circuits, Vol. 43, No. 2, February 2008, pp. 566-576, which is incorporated herein by reference.

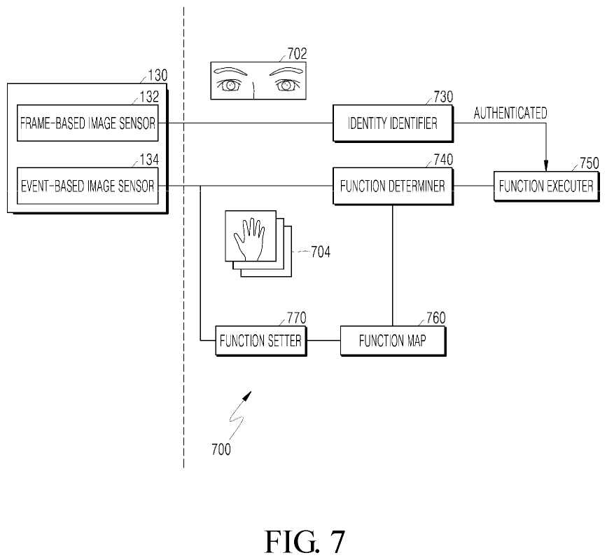

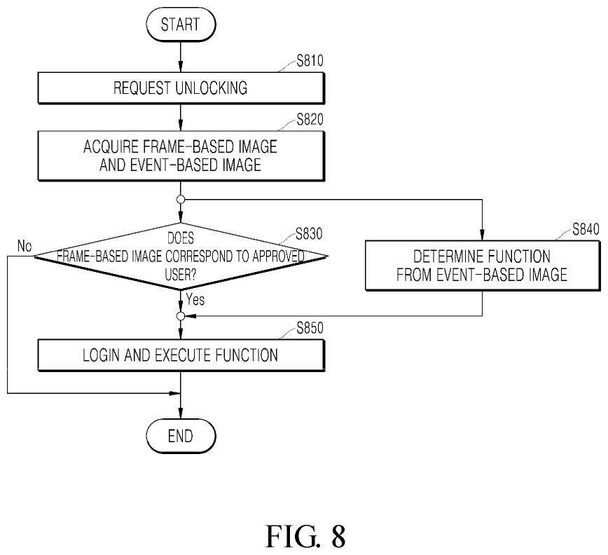

FIG. 7 is a block diagram schematically illustrating a user authentication and function execution engine according to another embodiment of the present disclosure, and FIG. 8 is a flowchart illustrating a method of simultaneously performing user authentication and function execution according to another embodiment of the present disclosure.

The user authentication and function execution engine 700 includes a feature extractor 710, an identity identifier 730, a function setter 740, and a function executer 750. The user authentication and function execution engine 700 may be a software module which is logically configured using resources of the processing unit 110 and the memory 120, or a hardware module configured by hardware.

In an embodiment illustrated in FIG. 7, the image acquiring unit 130 includes a frame-based image sensor 132 and an event-based image sensor 134. The image acquiring unit 130 may include a frame-based image sensor 132 and an event-based image sensor 134 which are individually coupled to individual lens, or may include a combined frame- and event-based image sensor coupled to one lens.

In step S810, the user is not logged in to an application which is executed on the electronic device 100. The user manipulates the user interface 150 of the electronic device 100 (for example, touches a touch screen or manipulates a mouse) to request login.

In step S820, the processing unit 110 activates the image acquiring unit 130 in order to login, and the user authentication and function execution engine 700 receives a frame-based image 702 from the frame-based image sensor 132 and an event-based image 704 from the event-based image sensor 134. The frame-based image sensor 132 may be a general-purpose image sensor (for example, a camera sensor of the related art) or a dedicated image sensor (for example, an iris sensor or a fingerprint sensor) for detecting a biometric feature. When the frame-based image sensor 132 is a general-purpose image sensor, substantially the same processors as the processors in the feature extractor 210, the interpolator 220, and the identity identifier 230, described above with reference to FIGS. 2 and 3, may be performed to authenticate the user. For the descriptions of various embodiments, the process performed when the frame-based image sensor 132 is a dedicated image sensor for detecting a biometric feature will be described below.

In step S830, the identity identifier 730 identifies the identity of the user based on the frame-based image 702 from the frame-based image sensor 132. The identity identifier 730 determines whether the frame-based image 702 corresponds to an approved user. The identity identifier 730 includes an artificial neural network which is trained in advance to determine the identity of the user from the biometric feature (for example, an iris) of the frame-based image 702, and provides the frame-based image 702 to the artificial neural network as input data to perform identity identification. When it is determined that the frame-based image 702 corresponds to the approved user, the identity identifier 730 notifies the function executer 750 that the user is authenticated.

In step S840, the function determiner 740 determines a function to be executed from the event-based image 704 from the event-based image sensor 134. The event-based image 704 may be an image which changes over time, for example, a moving image. The function determiner 740 may remove a noise, remove a redundant region, or pre-process the event-based image 704 to amplify effective data. The function determiner 740 may include an artificial neural network which is trained in advance to identify a dynamic pattern of the event-based image 704. The function determiner 740 may input the event-based image 704 which changes over time to the artificial neural network, and may determine a function to be executed from a pattern in the event-based image 704 which is identified by the artificial neural network by referring to a function map 760.

The artificial neural network is trained to identify the dynamic pattern from the event-based image 704 by the function setter 770. The function setter 770 may request the user to perform a specific action. For example, the user performs an action of moving a hand from left to right with an index finger unfolded, and the function setter 770 acquires an image (event-based image 704) which changes over time using the event-based image sensor 132. The function setter 770 provides the acquired event-based image to the artificial neural network as training data. The function setter 770 may request the user to repeat the same action until the artificial neural network learns a common dynamic pattern from the event-based image. When the artificial neural network identifies the common dynamic pattern from the repeated actions of the user, the function setter 770 may request the user to input a function to be executed for the identified dynamic pattern. The function setter 770 maps the function to be executed to the identified dynamic pattern, and stores the mapped function and dynamic pattern in the function map 760.

For example, the artificial neural network may be trained to identify the dynamic pattern based on a movement of a mouth in the event-based image 704, for example, by a lipreading technique. The artificial neural network may be trained to identify the dynamic pattern based on the number of unfolded fingers and a moving direction of the hand. The function map may map a dynamic pattern of moving the hand from right to left with unfolded index and middle fingers to a first function of the application, and map a dynamic pattern of the mouth which pronounces a specific word to a second function of the application.

In step S850, when the function executer 750 receives notification from the identity identifier 730 that the user is authenticated and receives notification from the function determiner 240 of the identified function, the function executer 750 executes the identified function simultaneously with the user login. Accordingly, the user login and the function execution can be performed substantially simultaneously and user-selectively in the application executed in the electronic device 100.

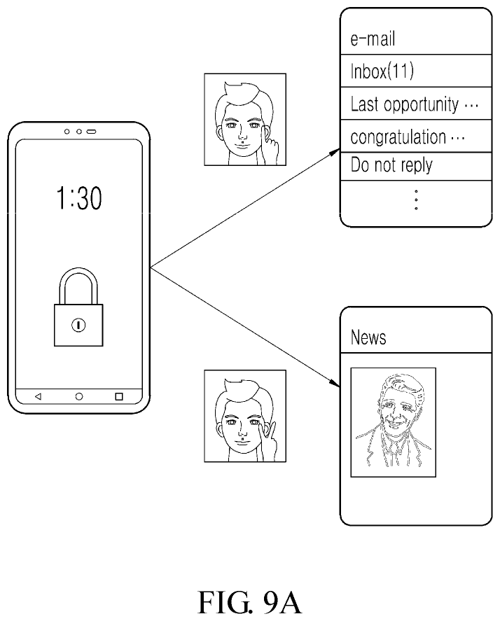

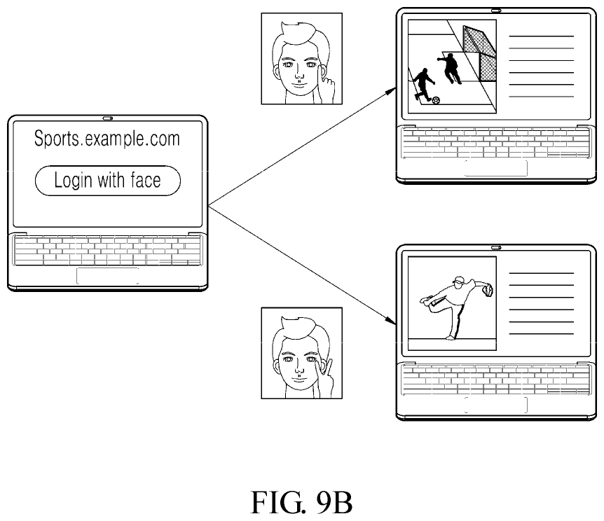

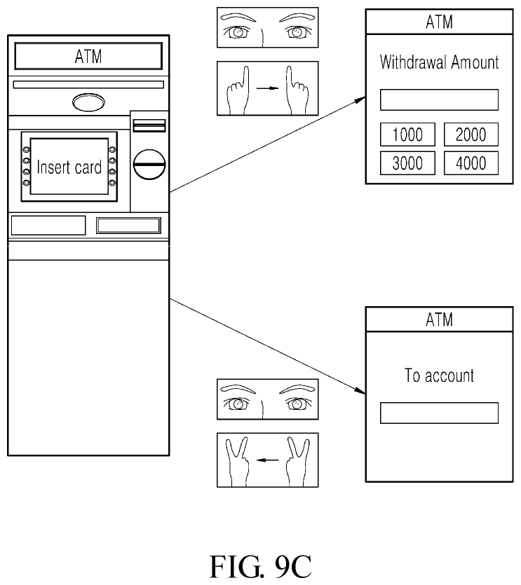

FIGS. 9A to 9C illustrate various exemplary embodiments to which the present disclosure is applied.

FIG. 9A illustrates an example in which the present disclosure is applied to a mobile phone. The mobile phone is initially locked. The mobile phone detects a user image with one unfolded finger and opens an e-mail inbox. The mobile phone detects a user image with two unfolded fingers and opens a news web page.

FIG. 9B illustrates an example in which the present disclosure is applied to an Internet website. Initially, the user is not logged in the website. The website detects a user image with one unfolded finger and moves to a football section. The website detects a user image with two unfolded fingers and moves to a baseball section.

FIG. 9C illustrates an example in which the present disclosure is applied to an ATM. In one example, a user inserts a bank card into a card slot of the ATM and moves a hand from left to right with an unfolded index finger. The ATM recognizes an iris of the user to authenticate the user, and simultaneously determines to execute a cash withdrawal function from the hand motion of the user. The ATM outputs an interface for inputting a withdrawal amount. In another example, a user inserts a bank card into a card slot of the ATM and moves a hand from right to left with unfolded index and middle fingers. The ATM recognizes an iris of the user to authenticate the user, and simultaneously determines to execute a wire transfer function from the hand motion of the user. The ATM outputs an interface for inputting a bank account to transfer the money.

According to the above-described embodiments of the present disclosure, by combining two steps of processes of user authentication and function execution into a one step process, the time taken from the user authentication to function execution can be shortened. Further, a function to be executed can be selected from an image obtained when the user authentication is performed, thereby increasing a user's convenience.

The example embodiments described above may be implemented through computer programs executable through various components on a computer, and such computer programs may be recorded on computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program instructions, such as ROM, RAM, and flash memory.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present application (especially in the appended claims), the terms “a/an” and “the” include both singular and plural references, unless the context clearly conditions otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Therefore, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

The present disclosure is not limited to the example embodiments described above, and rather intended to include the following appended claims, and all modifications, equivalents, and alternatives falling within the spirit and scope of the following claims.

What is claimed is:

1. A method for performing user authentication and function execution simultaneously in an electronic device, the method comprising:
receiving image data from an image sensor;
extracting a biometric feature image and an additional feature image from the image data; and
executing a function corresponding to the additional feature image when the biometric feature image corresponds to an approved user.

2. The method according to claim 1, wherein the electronic device is in a locked state before receiving the image data, and
executing a function comprises unlocking the electronic device and executing the function simultaneously.

3. The method according to claim 1, wherein executing a function comprises executing an application corresponding to the additional feature image.

4. The method according to claim 1, wherein executing a function comprises:
providing the additional feature image as an input to an artificial neural network which is trained in advance to identify a pattern in the additional feature image;
determining a function to be executed, based on a pattern determined by the artificial neural network; and
executing the determined function.

5. The method according to claim 4, wherein the pattern comprises at least one of a facial expression, a head angle, a mouth shape, a hand shape, or a number of fingers.

6. An electronic device for performing user authentication and function execution simultaneously, the electronic device comprising:
an image sensor configured to detect light to generate image data;
an identity identifier configured to determine whether the image data corresponds to a user based on a static component of the image data;
a function determiner configured to determine a function to be executed based on a dynamic component of the image data; and
a function executer configured to execute the determined function when the image data corresponds to an approved user.

7. The electronic device according to claim 6, wherein the image sensor comprises a frame-based image sensor and an event-based image sensor, the static component of the image data is generated based on data from the frame-based image sensor, and the dynamic component of the image data is generated based on data from the event-based image sensor.

8. The electronic device according to claim 6, wherein the static component of the image data comprises an image of a face, an iris, or a fingerprint of the user.

9. The electronic device according to claim 6, wherein the dynamic component of the image data comprises an image of a hand or a mouth which moves over time.

10. The electronic device according to claim 6, wherein the function determiner determines a function to be executed using an artificial neural network which is trained in advance to identify a pattern which moves over time, from a moving image.

11. An electronic device, comprising:
an image sensor configured to detect light to generate image data;
one or more processors; and
a memory storing a computer program,
wherein the computer program comprises instructions for, when executed by the one or more processors:
receiving the image data from the image sensor,
identifying a biometric feature and an additional feature from the image data, and
executing a function corresponding to the additional feature when the biometric feature corresponds to an approved user.

12. The electronic device according to claim 11, wherein the electronic device is in a locked state before receiving the image data, and
the instructions for executing a function corresponding to the additional feature comprise instructions for unlocking the electronic device and executing the function corresponding to the additional feature simultaneously.

13. The electronic apparatus according to claim 11, wherein the instructions for executing a function corresponding to the additional feature comprise instructions for executing an application corresponding to the additional feature.

14. The electronic device according to claim 11, wherein the memory stores a function map in which a plurality of functions to be executed and a plurality of patterns of the additional features are mapped to each other, and
the instructions for executing a function corresponding to the additional feature further comprise instructions for:
determining that the identified additional feature corresponds to one of the plurality of patterns, and
determining a function corresponding to the determined pattern in the function map as a function to be executed.

15. The electronic device according to claim 14, wherein the plurality of patterns comprises at least one of a facial expression, a head angle, a mouth shape, a hand shape, or a number of unfolded fingers.

16. The electronic device according to claim 11, wherein the image sensor comprises an event-based image sensor, and the additional feature is identified by data from the event-based image sensor.
